(19) United States
(12) Patent Application Publication
(10) Pub. No.: US 2012/0254084 A1
(43) Pub. Date: Oct. 4, 2012

(54) PASSENGER MOTION PREDICTION AND OPTIMIZATION SYSTEM

(75) Inventors: Stefan RICHTER, Hamburg (DE); Arnd SCHIRRMANN, Hamburg (DE); Stephan TIECK, Hamburg (DE); Stefan VOSS, Hamburg (DE)

(73) Assignee: EADS DEUTSCHLAND GMBH, Ottobrunn (DE)

(21) Appl. No.: 13/450,555

(22) Filed: Apr. 19, 2012

Related U.S. Application Data
(63) Continuation of application No. PCT/EP2010/065693, filed on Oct. 19, 2010.

(30) Foreign Application Priority Data
Oct. 19, 2009 (DE) 10 2009 049 923.7

(51) Int. Cl. G06F 15/18

(52) U.S. Cl. 706/14

(57) ABSTRACT

A method and a device are provided for predicting passenger movement in airports. Based on movement characteristics such as walking speed class and one or more points of interest of an individual passenger that are preferred by this passenger, a path is predicted for this passenger through the airport from a check-in counter, via the points of interest, to a gate. With reference to the predicted path, an estimated time of arrival of the passenger at the gate can be predicted.

### CROSS-REFERENCE TO RELATED APPLICATIONS

This is a continuation of International Application No. PCT/EP2010/065693, filed Oct. 19, 2010, which application claims priority to German Application No. 10 2009 049 923.7, filed Oct. 19, 2009, which are hereby incorporated by reference in their entirety.

### TECHNICAL FIELD

The technical field relates to a device and a method for predicting passenger movement in airports.

### BACKGROUND

The management of passenger numbers and movement in large airports, train stations or bus stations requires an increasing amount of resources. Some large airports have a throughput of several million passengers per year.

Airlines which land at these airports have an interest in this large number of passengers reaching the respective gates safely and efficiently so that the air traffic runs smoothly. Airport management is of course also interested in this smooth running. However, the commercial interest in air traffic running smoothly must not undermine the regulations imposed by law, such as safety checks etc.

Planners are therefore faced with the object of developing airport management systems which ensure the smoothest possible running of air traffic while complying with the respective legal requirements. The running of air traffic is also made difficult in that airports provide a large number of shops, restaurants, shopping opportunities and other distractions for the passengers.

Previous solutions to the problem are distinguished in that they are more or less of a static nature. For example, simulation software which simulates the estimated passenger traffic flow is used in the planning of buildings, corridors etc. in airports. With reference to these simulation data, the corridors and spaces are then dimensioned accordingly. Other methods use statistical data in order to carry out the planning and distribution of resources at airports. This planning is carried out for the long term with regard to the following days or weeks.

Other systems, such as that disclosed in WO 2005/052885, primarily use geographical passenger coordinates in order to lead these passengers through the airport to their corresponding destination. The known methods and systems either do not allow for any real-time planning or any real-time management of passenger movement or become too complex in terms of the computational implementation thereof. In the execution thereof too, the methods and systems are merely targeted towards a one-way flow of information, that is to say, only from the system to the passenger.

In view of the foregoing, at least one object is to solve the above-mentioned problems in the prior art by providing a method and a device for predicting passenger movements in airports. In addition, other objects, desirable features and characteristics will become apparent from the subsequent summary and detailed description, and the appended claims, taken in conjunction with the accompanying drawings and this background.

### SUMMARY

According to an embodiment, the method comprises: in an initialisation step, the passenger data of a particular passenger are acquired. Next, with reference to the statistical weight, movement characteristics for this passenger are determined from the passenger data. This determination is carried out by a classifier. On the basis of these movement characteristics, a path is then predicted through a network of POIs starting from a starting point through to an end point. This prediction is plotted on a master graph, which shows a layout of the airport. In the master graph, all possible points of interest are stored together with passenger paths connecting these points of interest. The prediction is carried out by modifying or transforming this master graph in such a way that the predicted path results from a search of this adapted master graph. The movement characteristics comprise a passenger-specific, estimated average walking speed and a passenger-specific list of POIs which may be preferred by this passenger.

This adaptation step, which precedes the search step, additionally takes into account or is dependent on previously predicted paths of further passengers. The adaptation is carried out by modifications to the line costs (“walking times”) and/or “pausing times” at the nodes of the master graph as a function of the previously predicted paths. This consideration or adaptation is carried out by applying an additional time (“penalty”) to the pausing times and/or walking times. Using this feedback loop, which can also be carried out at a later stage after the path has been predicted, bottlenecks at the POIs can be taken into account. In this way, the prediction of paths of subsequent passengers could also be influenced by alternative paths being calculated for these passengers. Bottlenecks at the POIs in question can thus be prevented or relieved.

In other words, the prediction step comprises two sub-steps: a master graph adaptation step and a subsequent search step which searches for a path in the thus adapted master graph. The search is carried out in the thus adapted/adjusted master graph with reference to route criteria and/or time criteria, from the start, via the preferred point(s) of interest, to the destination. The thus located path is the (passenger-specific) predicted path. The adaptation carried out previously, that is to say before the search, by modifying the master graph is carried out as a function of the movement characteristics and the previously predicted paths of other passengers, therefore as a double function.

The airport or the airport grounds are shown, according to an embodiment, as a “network” (=the master graph) of the POIs (points of interest (for passengers)). The path, supplied by the method as the output, from the start point (for example check-in) to the end point (gate) or via the selection of passenger-specific POIs, can be carried out according to an embodiment as an annotated graph. In the following, the path and the version thereof which can be shown on a computer are identified with one another as an annotated graph. The representation in a computer system is carried as a whole or in part, either in a non-volatile (database, read-only memory) or a volatile (random access memory RAM or buffer memory) manner, said volatile manner for example for processing “on the fly”.

The path comprises nodes and lines between these nodes. The nodes represent the POIs selected by the classifier (and corresponding to an expected preference of the passenger), while the lines, which connect these POIs, represent the routes through the airport between these POIs. Pausing times (of the passenger at the respective POIs) are thus associated with the POIs, and passenger-specific walking times are associated with the lines, therefore the graph of the path is an annotated graph. Thus, for example, an estimated time of arrival (ETA) of the passenger at the end point (gate) can be predicted by summation over this path. By partial summation, up to a specific node, sub ETAs can also be identified for the POI corresponding to this node.

According to an embodiment, the method comprises a conditional correction step, which corrects the path as a function of acquired, actual position data of the passenger in the airport grounds. In particular, the “layout” of the predicted path is modified here. This takes place for example by modifying the nodes of the path (of the POIs), for example by re-sorting the nodes if the passenger should actually be at another POI with reference to the sub-ETA, or by accommodating a new node if the POI which is actually identified does not correspond to any of the preferred POIs.

According to an embodiment, the method comprises an optional step in which, on the basis of a user request acquired from the passenger in the form of a particular request to a POI, this requested POI is inserted in the predicted path. This adjusted path which is modified by user or passenger interactivity can then be summated and it can thereby be established whether or not the passenger is likely to be able to reach the end point in good time despite this additional POI. If not, a corresponding response in the form of a mobile telephone message or a corresponding call by the gate staff can be activated, for example.

According to an embodiment, the number of paths corrected by position data is registered in a further step. If the number of “erroneous predictions” is greater than an adjustable absolute or relative error limit value, then in a further step the statistical weights are updated or (finely) adjusted to determine the movement characteristics of the passenger on the basis of the error limit value. In this way, seasonal variations of the movement characteristics can be taken into account with respect to the walking speeds or the selection of preferred POIs. Therefore, a dynamic self-learning process can be implemented.

The computational effort of the correction of the path based on position data can thus be kept to a minimum. It is provided that the corrected paths are cached for example in a database, in order to thus be able to provide a data pool in case re-training for identifying new or updated statistical weights for determining movement characteristics is to be carried out. The system can thus be adjusted dynamically to seasonal variations and is thus configured flexibly.

The paths calculated according to the method are based primarily on predictions. This approach thus allows, in contrast to other systems from the prior art, a view of the actual paths of the passengers with “low granularity”. In other words, according to the method, predictions are primarily made based only on movement characteristics. A precise, constant determination or constant monitoring of the geographical coordinates of the individual passengers is unnecessary. The position data are only used for occasional correction interventions. Overall, the computational implementation is thus low even in the case of high passenger numbers and, despite the low computational implementation; a path can be calculated for each particular individual passenger.

According to another embodiment, a device for predicting passenger movements in airports is also provided.

### BRIEF DESCRIPTION OF THE DRAWINGS

The embodiments will hereinafter be described in conjunction with the following drawing figures, wherein like numerals denote like elements, and:

FIG. 1 is a schematic block diagram of the device according to an embodiment in an airport; and

FIG. 2 is a schematic flow chart of the method for predicting passenger movements in an airport.

### DETAILED DESCRIPTION

The following detailed description is merely exemplary in nature and is not intended to limit application and uses. Furthermore, there is no intention to be bound by any theory presented in the preceding background or summary or the following detailed description.

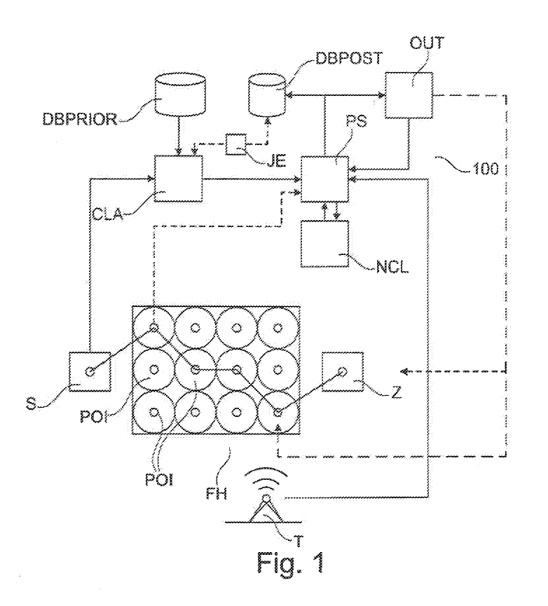

FIG. 1 is a schematic block diagram of a device 100 for predicting passenger movements at an airport FH. The airport FH, or the regions of the airport FH accessible to passengers, comprise a number of points of interest POIs, and a start point S (for example a check-in counter) and an end point Z (for example a gate). The points of interest POI can be, for example, restaurants, shops, meeting points, toilets etc.

After arrival at the airport, a passenger checks in at a particular check-in counter S. Within a particular time period, this passenger must then reach a particular gate Z correspondingly associated with the booked flight. On the way from the check-in S to the gate Z, the passenger will visit a number of points of interest POIs. The route of the passenger through the airport FH can be described by a path, which is systematically shown in FIG. 1 by the bold line. The path starts from the counter S, leads through a number of points of interest POIs and finally ends at the gate Z.

The device 100 for predicting passenger movements is configured in such a way that a passenger-specific prediction of this path is made possible. For this purpose, the device 100 comprises a path searching module PS, a classifier CLA and a data logger NCL for monitoring the passenger volume in the airport FH or at the individual POIs. The device 100 also comprises a locator T. The locator T is in communication with one or more checkpoints (not shown), which are arranged distributed throughout the airport FH.

All or some of these checkpoints can correspond to the POIs or some of the POIs. Using the locator T, position data of the passenger on their way from the check-in S to the gate Z can be acquired at adjustable points in time. The security check which each passenger has to pass through on their way to the gate Z would be, for example, a possibility for a suitable checkpoint which uses the infrastructure which is already available in the airport FH. The position data are data by which the precise position of the passenger at a particular point in time can be detected.

According to an embodiment, for example, it would be conceivable that the passenger is handed a boarding pass at check-in S which is provided with a radio-frequency identification (RFID) tag. Using corresponding sensors, which are arranged at the checkpoints, the ID of the passenger can be acquired at the point in time at which they pass through this checkpoint. The position data is transmitted to the locator T, which in turn transmits this position data to the data logger NCL and/or to the path searcher PS via a suitable communication network.

The points of interest POI are shown in FIG. 1 as circles with a marked centre. In this case, it should be made clear that the points of interest POI can also comprise a particular zonal region, for example a perimeter around a shop or a restaurant.

In the following, the precise cooperation of the path searcher PS for searching for the passenger-specific path to be predicted, of the classifier CLA for classifying the passenger according to walking speed and preferred POIs, and of the data logger NCL and the locator T will be described in greater detail. The path searcher PS receives up to three inputs in this case: from the classifier CLS, the data logger NCL and the positioning device T.

The path searcher PS, the classifier CLA and the data logger NCL are configured as computer-implemented modules, for example as programmable microchips or as routines which can be executed on a computer system. The programming can be carried out in C, C++, using the boost library (for path searching) and in Java (classifier CLA and data logger NCL). The programming language depends on the selected computer architecture, for example PowerPC, Cell, GPGPU, x86 etc. and/or on the operating system, for example UNIX, Linux, Windows etc., and on the available libraries which are used for support during programming.

The three modules CLS, PS, NCL can be implemented on a single computer system, or in a distributed computer system which is connected in a communication network by suitable protocols. The same is true for the further “units” or “modules”. A prediction which is passenger-specific, that is to say specific to the individual passenger, of the path from the check-in S via a number of POIs to the gate Z is produced as a result of this cooperation.

More precisely, the output of the path is an annotated graph which represents this passenger-specific path. The graph is a data structure in which a number of nodes are associated for each passenger, which nodes are interconnected via lines in a chain-like manner. The first node represents the check-in desk S and the last node represents the gate Z. In between, each node corresponds to one of the POIs. A passenger-specific pausing time is associated with each of these POIs. An expected passenger-specific walking time (“line cost”) is associated with each line. This walking time corresponds to the passenger-specific time which the passenger requires to go from one node (that is to say either check-in S or one of the POIs) to the adjacent node (POI or gate Z). Suitable data structures for the master graph, the adapted master graph and the path, which can be shown on a computer and/or can be processed by a computer, are, in addition to incidence and adjacency matrices, list structures (incidence or adjacency). A computer-internal representation can be implemented by pointers.

When the passenger checks in at check-in S, the passenger data for this passenger are acquired. Additionally, an initial position of the passenger is also given by the location of the check-in counter S. If the passenger checks in remotely at home or on the way to the airport via a laptop, mobile telephone or personal digital assistant (PDA), then the entrance hall to the terminal of the respective airline is taken as the starting point. If the passenger subsequently passes through this region, he/she is detected by the system T (for example via Bluetooth or by an RFID chip in his/her mobile telephone) and his/her planned route including the times is compared with the current detection data and re-calculated if necessary. In this way, it is also possible to predict delays to passengers who are not yet in the region of the infrastructure of the system T, since they still have to take a “minimal” route within the terminal to reach the departure gate or another destination.

This starting position, together with the passenger data, is transmitted to the classifier CLA via a suitable communication network. The position data can be, for example, age, profession, sex, mobility (that is to say disabled or able-bodied, or that the passenger, according to a profile (for example stored by the information technology of the airline), tends to select a preferred means of movement at the airport, such as stairs, escalators, moving walkways or lifts), nationality of the passenger, as well as check-in date and flight destination.

The classifier has access to a database DBPRIOR. Statistically identified data are stored in the database DBPRIOR. These statistical data can be obtained, for example, by polling. In the following, it is assumed that these statistical data are already available. On the basis of suitable statistical estimation methods, the classifier classifies the passenger with respect to two movement characteristics: on one hand, with respect to the average walking speed to be expected of the passenger, and on the other hand with respect to a selection of preferred POIs (hereinafter referred to as POIPs) from all of the POIs available at the airport FH. The POIPs, or preferred POIs, are those that are expected to be of interest to the individual passenger.

According to another embodiment, classification takes place according to the preferred means of movement at the airport. Values are preferred which do not have too many characteristics (for example two to three), since the classifier CLA otherwise has too many possibilities and the probability of misestimating increases. For example, the walking speed to be expected based on age, sex or mobility can be estimated from the statistical data in the knowledge database DBPRIOR. The classifier uses adjustable statistical weightings here, by which the classification can take place.

In order to make a classification with respect to the preferred POIPs, a suitable statistical weighting for the passenger data of age, sex, profession and nationality is taken as a basis. For example, from the nationality (is the passenger a foreign person in relation to the location of the airport FH] (yes/no?) it can be concluded that this passenger will preferably spend time in those shops (POIPs) in which souvenirs of the country in which the airport FH is located are sold.

In order to estimate the preferences of the individual passenger as precisely as possible, the classifier CLA is initially trained with reference to the collected statistical data if a decision diagram or a neural network is being used. For this purpose, the collected data are analysed and are searched for patterns, which are decisive as to why a person behaves as they do (=preference). These pattern-preference correlations are stored and as soon as a person with similar characteristics is detected, these correlations are activated again and thus the still “unknown” passenger is associated with the group previously used while training the classifier CLA.

According to another embodiment, an adjacency search can also be used in such a way that training is unnecessary. In the case of the adjacency search, the weighting of individual attributes is established and an association with a previously defined class is obtained after the classification. The classifier CLA thus supplies, for example, a data structure (for example an alphanumerical “tuple”) as an output for each passenger by the passenger ID being associated with a speed class and a list of preferred POIPs. The classifier can be configured here such that all of the POIs, or only those POIs at which the passenger-specific stopping probability is greater than a configurable minimum value, are taken into account.

The classifier CLA is configured as a two-step classifier. The output of the first step acts in this case as input for the second step. Classification takes place first with regard to the walking speed and, based on this first classification, the list of the preferred POIs is estimated or determined in a second step. It has been found in simulated test runs that the speed class is easy to estimate since it is primarily determined by age, sex and level of disability. All of the further attribute classes have a relatively high level of errors, which can be minimised by using further attributes (for example speed class).

According to other embodiments, the order can be varied thoroughly in the course of re-training of the classifier since the attributes used for training do not necessarily have to comprise all of the attributes which are available in principle. Preferably, the attributes and the order of the classification are selected in such a way that, for the majority, there is a clearer class association in subsequent operation. After classification is carried out, the tuple of the walking speed class is then transmitted together with the list of the preferred POIs as an input to the path searches PS.

On the basis of the classified walking class and the preferred POIs and the paths of other passengers in the NCL which have previously been determined and which reflect the current passenger volume at the POIPs/POIs, a master graph is adapted by corresponding modifications to the nodes and lines thereof. The search space is adapted passenger-specifically by taking into account the utilized capacity at the POIs/POIPs, or the routes between these. In this thus adapted master graph, the path searcher PS searches with reference to a suitable search algorithm in a thus given matrix-type data structure, which shows the layout of the POIs in the airport, for the optimum path. Optimization takes place with respect to selectable statistical criteria, for example the shortest route etc. For example, it can be seen from FIG. 1 that the matrix showing the airport FH is a matrix (=master graph) having three columns and four rows. A matrix entry corresponds in this case to one of the POIs. In the respective matrix entries, the distances between the respectively adjacent POIs are recorded.

Via the infrastructural layout of the terminal building, a “network” is positioned according to the division into zones (FIG. 1), which network corresponds to a directed graph (makes the detection of “one-way routes” due to security regions possible) and weighted/annotated graph (times at the master lines and master nodes). The master graph covers the entire building with all of the regions and is assigned average values for throughput times at the lines and nodes.

If people who have previously been recorded in the data logger NCL are now positioned at various points in this network, then there is an increase in the density of people at corresponding points, a respective slowing of the walking speed and thus an increase in time spent on the master line. In this way, the master graph can dynamically be adapted to the volume at the POIs before the search. According to another embodiment, this adaptation based on the NCL is triggered additionally by the data logger NCL in a subsequent phase. See more on this point below.

This utilized capacity which already exists in the master graph is stored in the data logger NCL and acts from this point onwards as an additional basis for the prediction of passenger paths. All further limitations are taken into account by the path searcher PS during the path search. These include the limitations of the master graph for passengers who are not authorised to enter particular zones (for example, EU passengers do not enter the duty-free region). These limitations speed up the path search due to the smaller search space, and, when a passenger plans a route to an intermediate point of interest, which the system 100 makes possible according to an embodiment, he/she is prevented from being led into restricted regions.

The classification results of the classifier CLA are applied to the master graph or are plotted thereon. Depending on the walking class or speed class of the passenger, a factor is applied to the standard times of the master graph (or of the master graph corrected by the NCL) at the master nodes, where the passenger is en route for a longer or shorter period of time. The POIPs have an influence on individual master lines on the master graph: routes or master lines which do not lead to POIPs are artificially penalised by a factor.

According to an embodiment, these master nodes which are not POIPs are not removed from the graph so that they are available as alternatives for path determination in the case of excessive utilization (congestion). The route along the POIPs is thus not carried out at any cost. The newly determined path of the passenger is stored in the data logger NCL, so that when calculating for subsequent passengers the thus added numbers can be taken into account. The path searcher PS searches the master graph, thus adapted, that is to say “customised” to the passenger, for the quickest and/or most economical route, according to the algorithm used.

In order to match the predicted passenger-specific path to the path actually taken by the passenger, the path searcher PS is communicatively connected to the locator T. In this case, position data are transmitted to the path searcher PS at particular points in time. If necessary, or optionally, the predicted path is then corrected. It is checked whether the point of interest which was actually visited by the passenger which is determined from the position data, falls under the preferred POIs, on which basis the path searcher PS generated the predicted path. If this is not the case, the predicted path is thus either supplemented by this point of interest which was actually visited, or one of the preferred POIs is replaced by the POI which was actually visited, or the predicted pausing times and/or the line costs of the POIPs are adapted.

The thus predicted paths or the predicted path optionally corrected on the basis of the position data are transmitted to the data logger NCL for each passenger or for each n^{th} (n>1) passenger. The data logger NCL can thus monitor how many passengers are expected to visit the respective (preferred) POIs. If each passenger path NCL is detected, a very precise assessment can be made. If the detection is only carried out for every n^{th} passenger or at random in terms of a statistical sample, an acceptable accuracy can also be achieved and, for example, CPU resources can be saved.

According to an embodiment, the data logger NCL supplies a signal to the path searcher PS in a feedback loop if the number of estimated passengers at a particular POI reaches a critical number. In this case, the predicted path of a particular passenger is then re-predicted by the path searcher PS by the master graph being re-adapted again before the search with reference to the current passenger paths in the NCL. The adaptation is carried out, as it also is at the start, by applying additional time to the pausing time at the overcrowded POI, as long as this POI comes under the preferred POIs of the passenger. Additionally, the line costs of the predicted or corrected paths can be loaded since, because of the overcrowded POI, the walking time between this overcrowded POI and adjacent POIs is expected to lengthen. Therefore, using the feedback from the data logger NCL, bottlenecks are taken into account.

The thus predicted, corrected and/or NCL-adapted path is then passed to a post-processor unit OUT. Here, for example, an estimated time of arrival (ETA) of the passenger at the gate Z can then be transmitted beforehand by summation over the predicted, corrected or NCL-adapted path. The ETA can then be transmitted to the gate Z in question. The staff at the gate Z can then arrange for a corresponding call to be made for the passenger to come to the gate Z immediately, as soon as the expected arrival time suggests a passenger delay.

Alternatively or additionally, a corresponding, for example, SMS (short message system) can also be sent to the mobile telephone of the passenger, if he/she has a mobile telephone. This requires the passenger to be registered for this delay warning service by their mobile telephone. Alternatively, a registration of this type can be automatically carried out at check-in. In this case, the passenger data also include the mobile telephone number of the passenger.

In a further embodiment, the device 100 also provides an enabling device interactivity between the path searcher PS and the passenger. According to this embodiment, for example, the passenger can transmit a request regarding alternative points of interest POIs via the mobile telephone. These requests are used to modify the predicted path by including the requested points of interest in the graph of the path. The predicted path is thus supplemented by the requested points of interest according to the desires of the passenger, and the thus modified path is supplemented by the pausing times or line costs based on the movement characteristics of the passenger.

This passenger-modified path is then passed to the post processor OUT and is summated again via the passenger-modified path in order to establish whether the requested point of interest would have led to the passenger arriving at the gate Z too late. If a delayed arrival is expected, a corresponding message is sent out to the mobile telephone of the passenger making the request.

According to a further embodiment of the invention, the device 100 also comprises means which allow the system 100 to adapt to seasonal trends in passenger behaviour in a self-learning process. For this purpose, the predicted and corrected paths are transmitted from the path searcher PS to a database DBPOST and are stored there. This occurs for every passenger, including the passengers for which a correction of the predicted path is carried out on the basis of position data supplied by the locator T. If the number of passengers for which a correction of this type is carried out exceeds a predetermined limit, it is thus to be presumed that these are passengers whose behaviour alters depending on the seasons. The data show a trend which is no longer correctly reflected by the statistical weights based on the classification or the search which is carried out in the CLA or the PS. The thus collected data pool of corrected paths in the database DBPOST can then be used to re-adjust or re-train the statistical weights in the classifier CLA or the search algorithms in the path searcher PS. This training phase can, in this case, be carried out simultaneously to normal operation, but can also be carried out when the airport is closed. The registration of the paths to be corrected is transferred by the device 100 into a self-learning process. This self-learning process ability can also be used to correspondingly train the system when it is newly installed in an airport, before it is put into regular operation. In an initialisation phase, the device 100 would then carry out the above-mentioned steps unnoticed by the passengers but would not supply any output to the post processor OUT. Instead, all of the data are deposited in the database DBPOST. As soon as the data pool has reached a statistically relevant size, the statistical weights can then be adjusted in the classifier CLA or the path searcher PS by using the knowledge data in the database DBPRIOR.

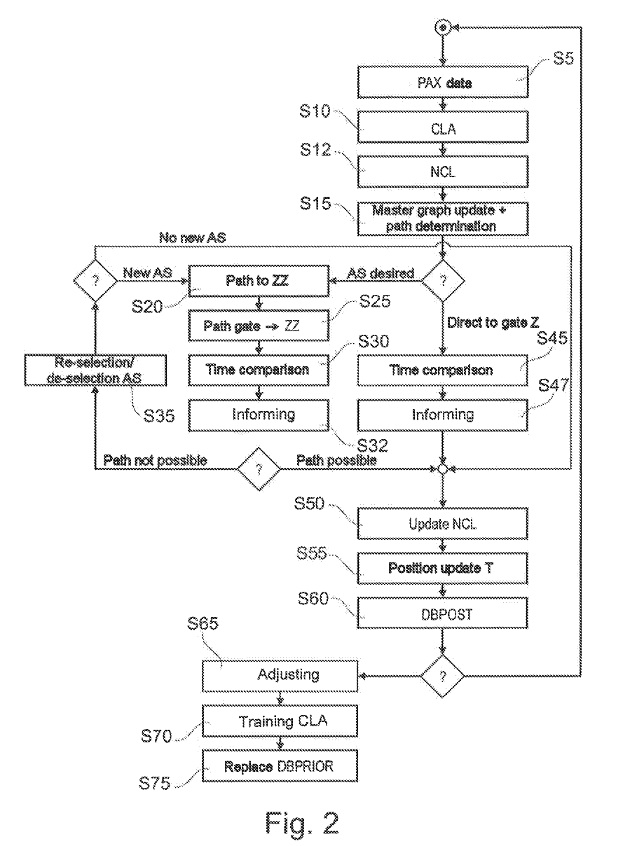

In FIG. 2, for the sake of clarity, the method implemented by the system 100 is shown in more detail with reference to a flow chart. The passenger data are acquired in step S5. In step S10, movement characteristics are determined from the acquired passenger data with regard to the passenger data of the passenger. Firstly, it is determined how quickly the passenger is estimated to move, and in a second sub-step it is then determined where the passenger has the greatest probability of moving to. That is to say, the list of preferred POIPs is determined.

In a step S12, previously predicted paths of other passengers which have been previously registered or buffered in the data logger NCL are detected. If there are no such previously acquired paths at this point in time, this step S12 is skipped. On the basis of these movement characteristics and of the path(s) of another passenger or other passengers registered in the NCL, the path starting from the starting point S, via the preferred POIs, to the end point Z is then determined in step S15. For this purpose, the master graph is adapted to the movement characteristics of the passenger and by taking into account the previously predicted paths of the other passengers, from the data logger NCL. In this way, irrelevant master graph lines are removed and/or master line costs (weights) are modified. Master graphs lines are irrelevant if they do not connect any of the preferred POIPs.

Additionally, the master graph line costs and/or pausing times at the master node points are adapted as a function of the previously predicted paths of the other passengers in the data logger NCL. The adaptation takes place by loading the pausing times and/or master line costs (=average walking times), in order to thus take into account a utilization degree caused by passenger numbers at the points of interest and the routes connecting them which are represented by the corresponding master graph nodes and master graph lines. This allows a current volume at the points of interest to be taken into account on the basis of paths which have previously occurred/been predicted. The higher the volume expected at the points of interest, the higher the loading on the corresponding master graph nodes and/or master graph lines. According to an embodiment, the loading occurs proportionally, that is to say when the volume increases at the master node, a previously established “default time” is likewise increased. In this case, according to an embodiment, an extrapolation function group which is non-linear and defined in portions is taken as a basis, since the walking time is non-linear: the walking time increases slowly from a particular density of people (approximately 0.5 persons/m²), then quite rapidly, and then levels off gently to an absolute standstill (at approximately 5.4 persons/m²).

According to an embodiment, the method can also be carried out in a loop beforehand in a data logger NCL filling phase up to and including step S15 and the subsequent registration of the thus determined path in the data logger NLC, until one or more paths are registered in the data logger. In this way, it can be ensured for every future step S12 that the data logger NCL is filled and step S12 can therefore be executed. Using this double adaptation of the master graph, that is to say as a function of the movement characteristics generated by the classifier CLA and of the current volume at the preferred points of interest which is registered in the NCL, an adapted graph is provided which is customised to the passenger and reflects the current passenger volume at the POIs/POIPs in the airport FH.

Next, in a subsequent sub-step of step S15, the path searcher PS searches for an optimum path in this thus adapted graph, starting from the start point S, via the POIPs, to the end point Z. Configuration can take place here as to whether optimisation is to take place with respect to route length or to (walking) time. Computation time can be saved during the search since the search is only executed in the adapted master graph having smaller dimensions (less lines and/or nodes).

In an optional step S20, a new intermediate point of interest (also “AS” in FIG. 2) can then be inserted in the predicted path on the basis of user feedback from the passenger. It is also made possible here for intermediate points of interest, which are explicitly desired by the passenger, to be taken account of in the prediction step for the path. If the passenger has transmitted user feedback of this type, an intermediate path to the intermediate point of interest is determined in step S20.

Starting from this intermediate point of interest, a residual path via the intermediate preferred POIPs to the gate Z is then determined in step S25. The steps S20 and S25 correspond in this case to the path determination step S15 except that the determination is now carried out respectively by taking into account the user-requested intermediate point. By this feedback to step S15, any modifications in the data logger NCL are also taken into account in the new search for the path supplemented by the requested intermediate point.

If the estimated time of arrival ETA, which is a result of the path supplemented by the intermediate point in steps S20 and S25, should exceed the time remaining before the gate closes, the passenger and, if necessary, the gate Z are informed of this in S32 in the form of a message which is then transmitted. The time is established by it being previously summated in step S30 via the current line costs and pausing times of the predicted path.

According to an embodiment, in such a case the passenger has the possibility of selecting another intermediate destination or completely omitting it in step S35. Alternatively, in step S35 a list of alternative intermediate destinations can be provided which can be reached in the remaining time. Without a poll for an intermediate point of interest, summation takes place over the thus determined or predicted path in a step S45, similar to step S30, over the now current path. On the basis of this summation, potential delays or navigational instructions are then transmitted to the passenger and/or to the staff at the gate Z in step S47.

In S50, the thus predicted and potentially supplemented path is stored in the data logger NCL in order to be able to adapt the paths of subsequent passengers by taking into account the previously predicted paths in a future step S15.

In a conditional step S55, the thus predicted path is corrected as a function of actual position data of the passenger in the airport (FH) grounds, which are supplied by the locator T. Here, nodes in the path are transposed, deleted or replaced depending on the current position of the passenger. A re-calculation is then carried out, as in step S15, in order to obtain a corrected or actual current path. Next, summation is carried out again, in a similar manner to steps S45 and S47, and, if a delay at the gate Z is impending, the passenger and/or the staff at the gate Z are informed. The corrective path update is triggered if, when checking the position data of the passenger, deviations from the predicted path are determined.

The checking step S55 takes place at adjustable time intervals. According to an embodiment, the time intervals can be selected to be so small that continuous checking is implemented. According to another embodiment, the checking intervals can be selected to be larger, in order to save calculating time. There is a deviation if the position detected at a point in time suggests a stop of the passenger at a current POI which does not come under the preferred POIPs of the predicted path. There is then also a deviation if the detected position suggests that the passenger has stopped at a different POIP than results from the predicted path by partial summation up to a particular POIP and comparison of the sub-ETA at this POIP.

Next, in S60, the corrected path is stored in the database DBPOST and, if necessary, the established deviation between the corrected path and the predicted path is noted. If this number of thus stored paths exceeds a particular limit 6, in step S65 the statistical weights, which are used in step S15 to determine the movement characteristics, are adjusted in light of these corrected paths. In this way, the season-dependent variations in the behaviour of passengers can be taken into account in a self-learning process in a subsequent determination step (classification step) S10 for future passengers.

Additionally or alternatively, the adjustment step S65 is or can be (also) triggered if the deviations between the paths stored in the database DBPOST and the predicted paths exceed an adjustable threshold value. If the limit δ and/or the threshold value is/are detected as being exceeded in this way, the classifier CLA is re-trained or initiated with reference to the paths stored in the database DBPOST in a step S70.

The data in the database DBPRIOR are replaced thereafter in step S75. An update of the new passenger preferences is thus carried out with regard to the preferred points of interest POIP using the data in the database DBPOST. From this point onwards, the database DBPOST is re-filled until the limit and/or the threshold value is reached again.

The precise sequence of the above-mentioned steps can also be varied dynamically or be repeated if necessary. In particular for example, the sub-step of adjustment by the data logger NCL in step S15 is re-implemented as a result of a signal from the data logger NCL to the path searcher PS. According to an embodiment this signal is transmitted if the data logger NCL detects a particular modification rate of registrations. This might suggest an increased passenger movement dynamic, which makes another load on the nodes and lines of the master graph necessary. The adapted master graph is thus only adapted to the NCL, and the optimum path for the passenger is sought again. The adaptation step with reference to the movement characteristics is no longer carried out in this repeated NCL adjustment step.

In summary, it can be said that by the device 100, it can be established at an early point in time whether a passenger will arrive at the gate Z either too late or not at all. In this case, the unloading of luggage of “no-show” passengers of this type can then be initiated for example in good time. The predicted, corrected or adapted paths can also be otherwise statistically evaluated or passenger movement patterns can be detected.

Calculation, by summation over the path, of the expected arrival time at the gate Z is only one specific application of the information content which is shown by this path. For example, highly frequented regions can also be detected, in order to optionally raise (seasonally) tiered rental fees of the shops or restaurants and to initiate location based advertisement. Retailers can likewise advertise special promotions through the system 100, in such a way that, in the case of path determination, the target group of the retailer will specifically pass his or her shop.

The available space in the airport FH can also be used more effectively, the deployment of staff within infrastructures can be improved and bottlenecks can be identified in good time and at short notice. Therefore, the passengers can take advantage of the convenience and flexibility, since the time until take-off or until the boarding time at the gate Z can be better utilised by intermediate stops at the points of interest.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for predicting passenger movement of a passenger in an airport, comprising:
acquiring passenger data of the passenger;
determining movement characteristics of the passenger from the passenger data with statistical weights;
conditionally acquiring a previously predicted passenger movement of a second passenger that was previously predicted if such a prediction is available;
predicting a path of the passenger from a starting point to an end point via a point of interest in the airport by taking the movement characteristics and the previously predicted passenger movement of the second passenger as a basis, the path storable as a graph and the graph comprising nodes and lines between the nodes; and
conditionally correcting the path as a function of obtained position data of the passenger, an actual position of the passenger in the airport that is derivable from the position data.

2. A method according to claim 1, wherein the predicting the path comprises:
adapting a master graph with reference to the movement characteristics and the previously predicted passenger movement, the master graph showing a layout of the airport, the master graph initially comprising master nodes that represent the points of interest and comprising master lines between the master nodes that represent routes between the master nodes; and
searching, with reference to configurable criteria, the master graph in order thus to obtain the predicted path.

3. The method according to claim 1, further comprising:
summation via line costs and pausing times of the path stored as a graph in order to obtain an estimated time of arrival of the passenger at the end point.

4. The method according to of claim 1, further comprising:
including a further point of interest in the predicted path,
wherein the including the further point of interest is conducted on a basis of a request transmitted by the passenger, and
wherein the including is only carried out if the summation over the supplemented path results in an estimated time of arrival that is compatible with previously defined time requirements at a destination.

5. The method according to claim 1, further comprising:
buffering the corrected path of the passenger if a path correction has been carried out; and
adjusting the statistical weights on a basis of which a determination of the movement characteristics for future passengers is to take place as soon as a number of the stored and corrected paths exceed a configurable limit.

6. The method according to claim 1, wherein the movement characteristics of the passenger comprise a predicted walking speed class of the passenger and at least one point of interest in the airport that is preferred by the passenger.

7. The method according to claim 6, wherein the determining of the movement characteristics is carried out in a first phase and a second phase that is successive to the first phase with the walking speed class determined in the first phase and the at least one point of interest determined in a second phase based on the walking speed class

8. A device for predicting passenger movement in an airport, the device comprising:
an acquiring unit that is configured to acquire passenger data of a passenger;
a classifier that is configured to determine movement characteristics of the passenger from the passenger data by statistical weights;
a data logger that is configured to register previously predicted passenger movements of other passengers;
a path searcher that is configured to predict a path of the passenger from a starting point, via a point of interest in the airport to an end point by taking the movement characteristics determined by the classifier and the passenger movement of other passengers registered by the data logger into account,
wherein the predicted path storable as a graph that comprises nodes and lines between the nodes,
wherein a correction by modification of the nodes of the predicted path conditionally is carried out by the path searcher as a function of the position data of the passenger, an actual position of the passenger in the airport that is derivable from the position data.

9. The device according to claim 8,
wherein the prediction of the path is carried out by the path searcher by adapting a master graph with reference to movement characteristics and to previously predicted passenger movement of other passengers, the master graph showing a layout of the airport, the master graph initially comprising master nodes that represent the points of interest and comprising master lines between the master nodes that represent routes between the master nodes,
wherein the adapting comprising modifying line costs of the master lines and subsequent searching with reference to configurable criteria of the master graph in order to obtain the predicted path.

10. The device according to claim 8, further comprising:
a post processor that is configurable for summation via line costs and pausing times of the path stored as a graph in order to obtain an estimated time of arrival of the passenger at the end point.

11. The device according to claim 8,
wherein the path searcher comprises interfaces that are configured to receive requests transmitted by the passenger, and
wherein the path searcher is configured to optionally insert a further point of interest in the path on a basis of the received request if the summation via the supplemented path results in an estimated time of arrival that is compatible with previously defined time requirements at a destination.

12. The device according to claim 8, further comprising:
a database configured to buffer the corrected path of the passenger and further corrected paths of further passengers if a path correction of is carried out by the path searcher; and
an adjusting unit that is configured in such a way that as a number of stored, corrected paths exceeds a configurable threshold value, the statistical weights of the classifier are adjusted in such a way that a determination of the movement characteristics for future passengers is carried out using the thus adjusted statistical weights.

13. The device according to claim 8, wherein the movement characteristics of the passenger comprise a predicted walking speed class of the passenger and at least one point of interest in the airport that is preferred by the passenger.

14. A computer readable medium embodying a computer program product, said computer program product comprising:
a predicting program for predicting a passenger movement of a passenger in an airport, the predicting program configured to:
acquire passenger data of the passenger;
determine movement characteristics of the passenger from the passenger data with statistical weights;
conditionally acquire a previously predicted passenger movement of a second passenger that was previously predicted if such a prediction is available;
predict a path of the passenger from a starting point to an end point via a point of interest in the airport by taking the movement characteristics and the previously predicted passenger movement of the second passenger as a basis, the path storable as a graph and the graph comprising nodes and lines between the nodes; and
conditionally correct the path as a function of obtained position data of the passenger, an actual position of the passenger in the airport that is derivable from the position data.

15. The computer readable medium embodying the computer program product according to claim 14, wherein the predicting program is configure to:
adapt a master graph with reference to the movement characteristics and the previously predicted passenger movement, the master graph showing a layout of the airport, the master graph initially comprising master nodes that represent the points of interest and comprising master lines between the master nodes that represent routes between the master nodes; and
search, with reference to configurable criteria, the master graph in order thus to obtain the predicted path.

16. The computer readable medium embodying the computer program product according to claim 14, the predicting program further configured to:
sum via line costs and pausing times of the path stored as a graph in order to obtain an estimated time of arrival of the passenger at the end point.

17. The computer readable medium embodying the computer program product according to claim 14, the predicting program further configured to:
include a further point of interest in the predicted path,
wherein the including the further point of interest is conducted on a basis of a request transmitted by the passenger, and
wherein the predicting program is configured to include the further point of interest if the summation over the supplemented path results in an estimated time of arrival that is compatible with previously defined time requirements at a destination.

18. The computer readable medium embodying the computer program product according to claim 14, the predicting program further configured to:
buffer the corrected path of the passenger if a path correction has been carried out; and
adjust the statistical weights on a basis of which a determination of the movement characteristics for future passengers is to take place as soon as a number of the stored and corrected paths exceed a configurable limit.

19. The computer readable medium embodying the computer program product according to claim 14, wherein the movement characteristics of the passenger comprise a predicted walking speed class of the passenger and at least one point of interest in the airport that is preferred by the passenger.

20. The computer readable medium embodying the computer program product according to claim 19, wherein the predicting program is configured to determine the movement characteristics in a first phase and a second phase that is successive to the first phase with the walking speed class determined in the first phase and the at least one point of interest determined in a second phase based on the walking speed class.
